(19) United States
(12) Patent Application Publication
(10) Pub. No.: US 2007/0193865 A1
(43) Pub. Date: Aug. 23, 2007

(54) Control panel assembly in washer

(75) Inventors: Yang Hwan No, Gyeongsangnam-do (KR); Jong Min Kim, Gyeongsangnam-do (KR); Han Ki Cho, Gyeongsangnam-do (KR); Ho Sung Jang, Gyeongsangnam-do (KR); Dong Hoon Kang, Busan (KR); Jung Hoon Kang, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Seoul (KR)

(21) Appl. No.: 10/555,785

(22) PCT Filed: Jun. 17, 2005
(86) PCT No.: PCT/KR05/01862

§ 371 Date: Apr. 5, 2007

(30) Foreign Application Priority Data
Jun. 24, 2004 (KR) 10-2004-0047630

(51) Int. Cl. H01H 13/00

(52) U.S. Cl. 200/296

(57) ABSTRACT

A control panel assembly in a washer is disclosed, in which a push button and a rotary knob can be selectively replaced to use without altering the control panel and a button guide frame. The present invention includes a push button or a rotary knob provided to a front side of control panel and a guide frame having a button receiving hole to receive the push button or the rotary knob therein so that either the push button or the rotary knob is selectively loaded in the guide frame.

### TECHNICAL FIELD

The present invention relates to a control panel assembly in a drum type washer, and more particularly, to a washer control panel having a button guide assembly that enables a selective use of a push button or rotary knob provided thereto.

### BACKGROUND ART

Generally, a control panel having operational buttons enabling a user to activate various functions of a washer and a display device displaying the user-selecting functions and progress states and the like are provided to an upper front part of cabinet of a drum type washer.

The operational button employs a push type button (hereinafter called a push button) to select a function in regular sequence by pressing a tact switch provided in rear of the button pushed by a user or a rotary knob enabling a selection of a specific step by rotating a button frame and a rotary volume.

In general, the push button has an upwardly convex cylindrical button frame and a switch push shaft is projected from a backside of the button frame in a rear direction to pressurize the tact switch provided in rear of the button. And, the push button, in which a restoring spring having elasticity is inserted to enable the push button pressed by the switch push shaft to return to its original position, is fixed to a button guide. Since the restoring spring needs to be assembled in a compressed state, the push button needs a fixing hook to be fixed to the button guide.

Meanwhile, the rotary knob means a knob made of a molded material fitted in the rotary volume that enables a selection of a specific function by moving a contact point of a substrate if a user rotates the frame.

The rotary knob has an upwardly convex cylindrical shape. And, a rotational shaft of the rotary volume is pressed to be fitted in a hollow fixing shaft provided to a rear side of the rotary knob.

The rotary knob does not have a separate fixing device. Instead, the rotational shaft of the rotary volume is pressed into the fixing shaft of the rotary knob to be fixed thereto.

Hence, the push button differs from the rotary knob in the fixing structure and the means for enabling a function selection. Hence, the button guide is differently configured according to the button type to be used.

Generally, in case of attempting to use the push button, the button guide consists of a portion to receive the frame of the push button therein and a portion having a fixing hole to lock the fixing hook, which fixes the push button, therein.

In case of attempting to use the rotary knob, the button guide receives the frame of the rotary knob therein and has a hole to be penetrated by the rotary volume.

However, since the button guide is differently configured according to the button type, the entire control panel including the button guide needs to be replaced to change the button type to use.

And, it is inconvenient that the design of the control panel has to be modified each time the button type is changed. Moreover, the corresponding cost is raised.

### DISCLOSURE OF INVENTION

Technical Problem

Accordingly, the present invention is directed to a control panel assembly in a washer that substantially obviates one or more of the problems due to limitations and disadvantages of the related art.

Technical Solution

An object of the present invention is to provide a control panel assembly in a washer, by which a push button and a rotary knob can be selectively replaced to use without altering the control panel and a button guide frame.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a control panel assembly in a washer according to the present invention includes a push button or a rotary knob provided to a front side of control panel and a guide frame having a button receiving hole to receive the push button or the rotary knob therein so that either the push button or the rotary knob is selectively loaded in the guide frame.

Preferably, the control panel further includes a fixing plate provided to a rear side of the guide frame to be detachably assembled to the push button.

More preferably, the fixing plate includes a push shaft fixing hole allowing a switch push shaft of the push button to be inserted and supported therein and a button fixing hole in which a fixing hook to fix the push button to the fixing plate is locked. More preferably, a plurality of fixing hooks are provided to an outer circumference of the guide frame to be uniformly spaced apart from each other and wherein a plurality of fixing holes are provided to the fixing plate to lock a plurality of the fixing hooks therein.

To further achieve these and other advantages and in accordance with the purpose of the present invention, a control panel assembly in a washer includes a guide frame having a button receiving hole at a central part of the guide frame to selectively load either a push button or a rotary knob therein, the push button having a switch push shaft pressurizing a tact switch in rear of the switch push shaft, the rotary knob having a hollow fixing shaft in which a rotational shaft of a rotary volume is fitted to be fixed thereto, if the push button is loaded in the guide frame, a fixing plate detachably assembled to rear sides of the push button and the guide frame, and a detachable member fixing the fixing plate to the guide frame detachably.

Preferably, the detachable member includes a plurality of fixing hooks provided to an outer circumference of a rear end portion of the guide frame to be evenly spaced apart from each other.

More preferably, the fixing plate includes a guide hook fixing hole confronting each of the fixing hooks to be penetrated by the corresponding fixing hook of the guide frame to be fixed thereto.

Preferably, the fixing plate includes a push shaft fixing hole allowing a switch push shaft of the push button to be inserted and supported therein and a button fixing hole in which a fixing hook to fix the push button to the fixing plate is locked.

Preferably, the rotary knob includes a flange outwardly extending in a vertical direction from an outer circumference of a rear end portion of the rotary knob to be supported by an inner circumference of the button receiving hole of the guide frame and to prevent the rotary knob from being detached from the guide frame.

More preferably, the flange of the rotary knob is provided to the outer circumference of the rotary knob entirely. More preferably, the flange of the rotary knob is provided to a portion of the outer circumference of the rotary knob.

To further achieve these and other advantages and in accordance with the purpose of the present invention, a control panel assembly in a washer includes a push button having a switch push shaft pressurizing a tact switch in rear of the switch push shaft, a rotary knob having a hollow fixing shaft in which a rotational shaft of a rotary volume is fitted to be fixed thereto, and a guide frame having a button receiving portion at a central part of the guide frame to selectively load either the push button or the rotary knob therein wherein the button receiving portion is backwardly concave to allow a frame of the push button or the rotary knob to be inserted and supported therein and wherein the button receiving portion has a flat bottom.

Preferably, a button fixing hole penetrated by a fixing hook for fixing the push button thereto is provided to the bottom of the button receiving portion of the guide frame to lock the fixing hook therein and a push shaft penetrating hole is provided to the bottom of the button receiving portion of the guide frame to allow the switch push shaft of the push button to be fitted and supported therein.

More preferably, the push shaft penetrating hole provided to the bottom of the button receiving portion is configured to allow the switch of the switch push shaft of the push button or the fixing shaft of the rotary knob to be inserted and supported therein.

Usable in common for the push button and the rotary knob, the present invention can selectively replace the push button and the rotary knob to use without replacing the control panel and the button guide frame according to the species of the operational button.

Advantageous Effects

The present invention can solve the problem of redesigning the control panel and the button guide to meet the push button and the rotary knob. Moreover, the present invention can solve the problem of the rise of the corresponding cost.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front diagram of a control panel and a button guide assembly in a drum type washer;

FIG. 2 is a cross-sectional diagram of a push button assembled to a control panel assembly in a washer according to a first embodiment of the present invention;

FIG. 3 is a cross-sectional diagram of a rotary knob assembled to the control panel assembly in the washer shown in FIG. 2;

FIG. 4 is a cross-sectional diagram of a push button assembled to a control panel assembly in a washer according to a second embodiment of the present invention;

FIG. 5 is a front diagram of the push button and fixing plate shown in FIG. 4;

FIG. 6 is a rear diagram of the push button shown in FIG. 5;

FIG. 7 is a cross-sectional diagram of the rotary knob assembled to a button guide assembly shown in FIG. 4; and

FIG. 8 is a cross-sectional diagram of the rotary knob assembled to a button guide assembly shown in FIG. 5 according to a second embodiment of the present invention.

### BEST MODE FOR CARRYING OUT THE INVENTION

Reference will now be made in detail to the preferred embodiments of the present invention, examples of which arc illustrated in the accompanying drawings.

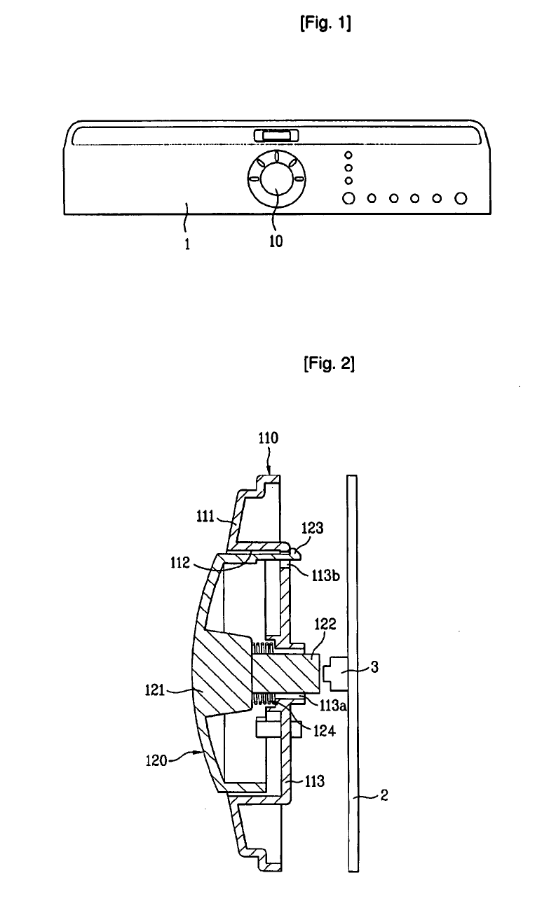

FIGS. 1 to 3 show a control panel assembly in a washer according to a first embodiment of the present invention.

Referring to FIGS. 1 to 3, a control panel assembly 1 is provided to an upper part of a drum type washer (not shown in the drawing) so that a user can select and operate a washer function and, an operational button and a button guide 10 are provided to a central part of the control panel assembly 1 to enable a selection of a washing course.

Within the control panel 1 provided are a printed circuit board (hereinafter abbreviated PCB) 2 having circuits, switches and the like for device operations and an insulator (not shown in the drawing) fixing the PCB 2, LED (light emitting diode) of the PCB 2, the switches, segments and the like to predetermined locations in the control panel 1.

The operational button includes a push button 120 enabling a function selection in regular sequence by being pushed by a user or a rotary knob 130 enabling a user to select a specific function by rotating a button frame.

The button guide 110 includes a button receiving portion 112 having a prescribed depth to enable the push button 120 or the rotary knob 130 to be held therein and a guide frame 111 having a fixing plane 113 forming a bottom of the button receiving portion 112 and configuring an upwardly convex disc shape to configure a body.

A plurality of button fixing holes 113b are provided to the fixing plane 113 of the button receiving portion 112 so that a button fixing hook 123 of the push button 120 penetrates the button fixing holes 113b to be locked therein. A push shaft penetrating hole 113 is provided to a center of the fixing plane 113 so that a switch push shaft 12 of the push button 120 is inserted in the push shaft penetrating hole 113a to be supported.

In this case, three button fixing holes 113 are provided to the fixing pane 113 in a circumferential direction to leave an angle of 120° each. And, each of the three button holes 113 is square.

The push button 120, as shown in FIG. 2, includes a button frame 121 forming a body, a switch push shaft 122, a button fixing hook 123, and a restoring spring 124.

The button frame 121 is configured to have an upwardly convex cylindrical shape of which backside is open to have a predetermined height. The switch push shaft 122 is provided to the backside of the button frame 121 to pressurize a tact switch 3 in rear of the switch push shaft 122. The switch push shaft 122 is projected in a rear direction from a center of a backside of a closed surface of the button frame 121. The switch push shaft 122 is preferably formed to have a predetermined length longer than an open side of the push button 120 in a rear direction. And, the switch push shaft 122 is inserted in the restoring spring 124, which is compressed, so that the button frame 121 can be elastically supported against the button guide 110.

The button fixing hook 123 extends from a lateral side of the button frame 121 and includes a plurality of hooks formed on a circumference of the open side of the button frame 121. Preferably, a plurality of the hooks arc spaced apart from each other by 120°

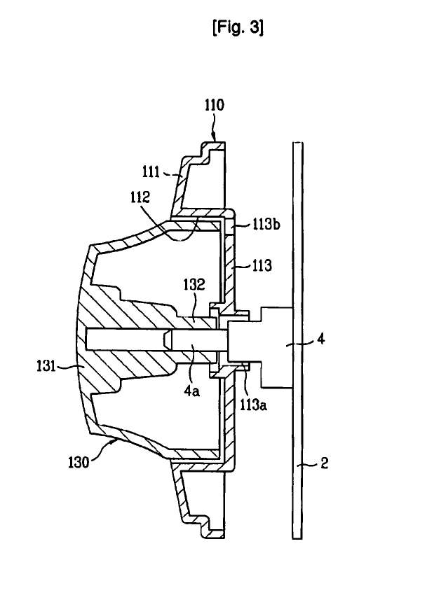

Meanwhile, the rotary knob 130, as shown in FIG. 3, includes a knob frame 131 forming an upwardly convex cylindrical body having an open backside and a fixing shaft 132 projected in a rear direction from a center of a backside of the knob frame 131.

A rotary volume 4 is fixed to the PCB 2. A rotational shaft 4a fitted in the fixing shaft 132 is provided to the rotary volume 4. And, the rotational shaft 4a is rotated together with the rotary knob 130 to select a prescribed function. Hence, it is preferable that the fixing shaft 132 includes a hollow shaft so that the rotational shaft 4a of the rotary volume 4 can be fitted in the fixing shaft 132 to be fixed thereto. Preferably, the rotational shaft 4a has a column shape having a semicircular cross-section to be fitted in a hollow portion of the fixing shaft 132 as well as to fix the rotary knob 130 thereto.

Meanwhile, while loaded in the button guide 110, the knob frame 131 preferably has a height enough to be upwardly projected from the button guide 110 so that a user can grab the knob frame 131 to enable a rotational operation.

Hence, in case of attempting to use the push button 120 as the operational button, the fixing hook 123 of the push button 120 is locked in the button fixing hole 113b of the button guide 110, the switch push shaft 122 is inserted in the restoring spring 124, and the switch push shaft 122 is then fitted in a push shaft penetrating hole 113a for assembly.

In case of attempting use the rotary knob 130 as the operational button, the frame 131 of the rotary knob 130 is inserted in the button receiving portion 121 of the button guide 110 and the rotational shaft 4a of the rotary volume 4 is then fitted in the fixing shaft 132 of the rotary knob for assembly.

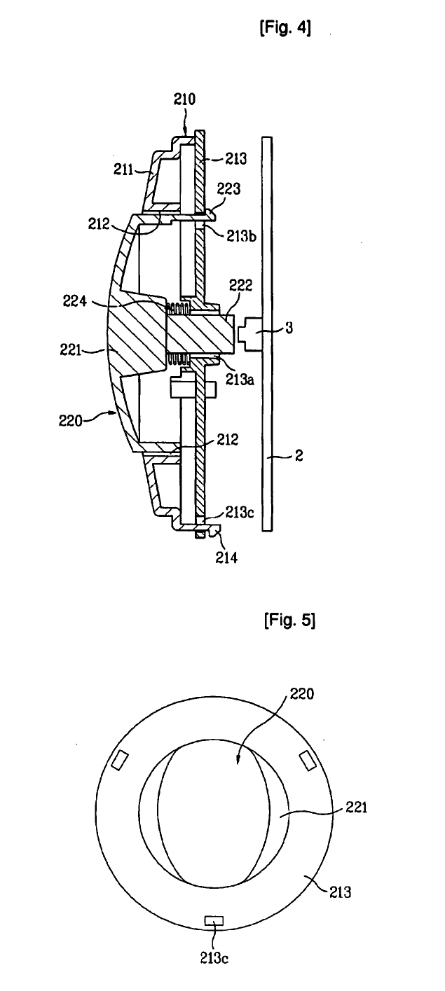

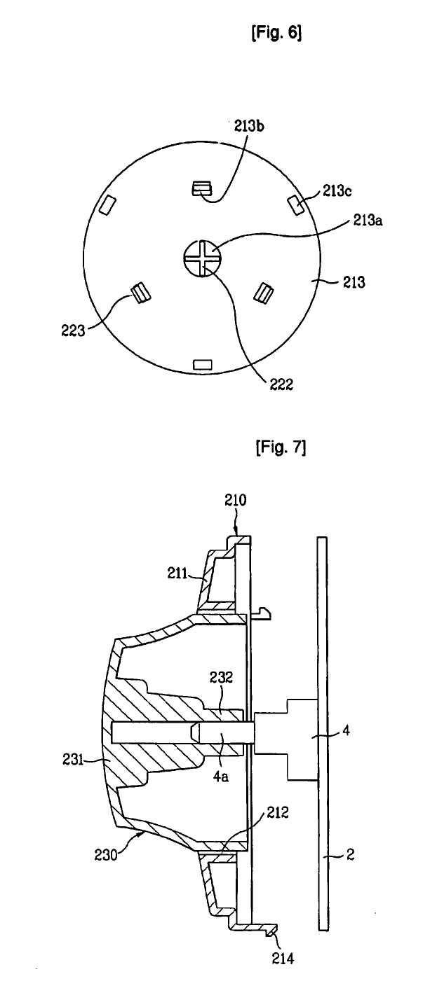

FIGS. 4 to 7 show a button guide 210 according to a second embodiment of the present invention.

Referring to FIGS. 4 to 7, a button guide 210 includes a disc type guide frame 211 having a button fixing hole provided open to a central part of the button guide 210 to have a predetermined height in an upper direction so that a push button 220 or a rotary knob 230 can be inserted in the button fixing hole 212, a plurality of guide fixing hooks 214 provided along an open outer circumference of the guide frame 211 to be spaced apart from each other with a uniform interval, and a fixing plate 213 detachably assembled to a rear side of the guide frame 211.

The fixing plate 213 includes a button fixing hole 213b penetrated by a button fixing hook 223 of the push button 220 to be locked therein and a guide hook fixing hole 213c in which the guide fixing hook 214 of the button guide 210 is locked. And, a push shaft penetrating hole 213a is provided to a center of the fixing plate 213 so that a switch push shaft 222 of the push button 220 is inserted in the push shaft penetrating hole 213a to be supported.

Like the push button 120 of the former embodiment, the push button 220, as shown in FIGS. 4 to 6, includes a button frame 221, a switch push shaft 222, a button fixing hook 223, and a restoring spring 224.

Besides, like the rotary knob 130 of the former embodiment, the rotary knob 230, as shown in FIG. 7, includes a knob frame 231, a rotary volume 4, and a fixing shaft 232 of a rotational shaft 4a of the rotary volume 4.

In case of attempting to use the push button 220 as the operational button, the frame 221 of the push button 220 is inserted in the button receiving hole 212 of the button guide 210, the switch push shaft 222 is inserted in the restoring spring 224, and the switch push shaft 222 then penetrates the push shaft penetrating hole 213a.

The fixing hook 223 of the push button 220 is locked in the button fixing hole 213b of the fixing plate 213 and the fixing hook 214 of the button guide 210 is locked in the guide hook fixing hole 213c.

In case of using the rotary knob 230 as the operational button, the fixing plate 213 is detached from the button guide 210, the frame 231 of the rotary knob 230 is inserted in the button receiving hole 212, the rotational shaft 4a of the rotary volume 4 is then fitted in a hollow portion of the fixing shaft 232 of the rotary knob 230 for assembly.

Meanwhile, the rotary knob 230 is fixed by the rotational shaft 4a of the rotary volume 4 only. To prevent the rotary knob 230 from being separated from the rotational shaft 4a in case of being pushed forward in use, a separation preventing flange 333 is preferably provided to an open circumference of the rotary knob 330. In this case, the separation preventing flange 333 is projected outward from the open circumference of the rotary knob 330 to be supported by an inner circumference of the button receiving hole 212 of the guide frame.

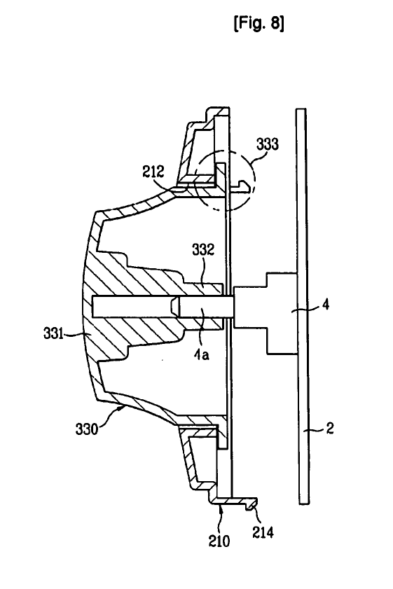

Alternatively, the separation preventing flange 333, as shown in FIG. 8, can be provided to an entire outer circumference of a rear end portion of the rotary knob 330. Alternatively, the separation preventing flange 333 can be projected from a prescribed portion of the open circumference of the knob frame 331 in part. Alternatively, the separation preventing flange 333 can be variously configured enough to be supported by the inner circumference of the button receiving hole 212 of the guide frame 211.

### INDUSTRIAL APPLICABILITY

Accordingly, the drum type washing machine according to the present invention is configured to use the push button and the rotary knob in common. It is unnecessary to replace the control panel and the button guide according to the species of the operational button to use. Hence, the push button can be simply replaced by the rotary knob to use, and vice versa. Moreover, the drum type washing machine according to the present invention can solve the problem of designing the control panel and the button guide to correspond to the push button or the rotary knob and the problem of the raised cost accompanied by the former problem.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A control panel assembly in a washer, comprising:
a push button or a rotary knob provided to a front side of control panel; and
a guide frame having a button receiving hole to receive the push button or the rotary knob therein so that either the push button or the rotary knob is selectively loaded in the guide frame.

2. The control panel assembly of claim 1, further comprising a fixing plate provided to a rear side of the guide frame to be detachably assembled to the push button.

3. The control panel assembly of claim 2, the fixing plate comprising:
a push shaft fixing hole allowing a switch push shaft of the push button to be inserted and supported therein; and
a button fixing hole in which a fixing hook to fix the push button to the fixing plate is locked.

4. The control panel assembly of claim 2, wherein a plurality of fixing hooks are provided to an outer circumference of the guide frame to be uniformly spaced apart from each other and wherein a plurality of fixing holes are provided to the fixing plate to lock a plurality of the fixing hooks therein.

5. A control panel assembly in a washer, comprising:
a guide frame having a button receiving hole at a central part of the guide frame to selectively load either a push button or a rotary knob therein, the push button having a switch push shaft pressurizing a tact switch in rear of the switch push shaft, the rotary knob having a hollow fixing shaft in which a rotational shaft of a rotary volume is fitted to be fixed thereto;
if the push button is loaded in the guide frame, a fixing plate detachably assembled to rear sides of the push button and the guide frame; and
a detachable member fixing the fixing plate to the guide frame detachably.

6. The control panel assembly of claim 5, wherein the detachable member comprises a plurality of fixing hooks provided to an outer circumference of a rear end portion of the guide frame to be evenly spaced apart from each other.

7. The control panel assembly of claim 6, the fixing plate comprising a guide hook fixing hole confronting each of the fixing hooks to be penetrated by the corresponding fixing hook of the guide frame to be fixed thereto.

8. The control panel assembly of claim 5, the fixing plate comprising:
a push shaft fixing hole allowing a switch push shaft of the push button to be inserted and supported therein; and
a button fixing hole in which a fixing hook to fix the push button to the fixing plate is locked.

9. The control panel assembly of claim 5, the rotary knob comprising a flange outwardly extending in a vertical direction from an outer circumference of a rear end portion of the rotary knob to be supported by an inner circumference of the button receiving hole of the guide frame and to prevent the rotary knob from being detached from the guide frame.

10. The control panel assembly of claim 9, wherein the flange of the rotary knob is provided to the outer circumference of the rotary knob entirely.

11. The control panel assembly of claim 9, wherein the flange of the rotary knob is provided to a portion of the outer circumference of the rotary knob.

12. A control panel assembly in a washer, comprising:
a push button having a switch push shaft pressurizing a tact switch in rear of the switch push shaft;
a rotary knob having a hollow fixing shaft in which a rotational shaft of a rotary volume is fitted to be fixed thereto; and
a guide frame having a button receiving portion at a central part of the guide frame to selectively load either the push button or the rotary knob therein wherein the button receiving portion is backwardly concave to allow a frame of the push button or the rotary knob to be inserted and supported therein and wherein the button receiving portion has a flat bottom.

13. The control panel assembly of claim 12, wherein a button fixing hole penetrated by a fixing hook for fixing the push button thereto is provided to the bottom of the button receiving portion of the guide frame to lock the fixing hook therein and wherein a push shaft penetrating hole is provided to the bottom of the button receiving portion of the guide frame to allow the switch push shaft of the push button to be fitted and supported therein.

14. The control panel assembly of claim 13, wherein the push shaft penetrating hole provided to the bottom of the button receiving portion is configured to allow the switch of the switch push shaft of the push button or the fixing shaft of the rotary knob to be inserted and supported therein.
